(19) United States
(12) Patent Application Publication
(10) Pub. No.: US 2022/0067774 A1
(43) Pub. Date: Mar. 3, 2022

(54) PRODUCT-BASED FARE CAPPING

(71) Applicant: Bytemark, Inc., New York, NY (US)

(72) Inventors: Stephanie Schrauth, Brooklyn, NY (US); Nicholas Ihm, Newtown, CT (US); Vishal Arora, Little Neck, NY (US); Shashidhar Yaranal, Bangalore (IN); Ram Roy, Bangalore (IN); Jyoti Mahansaria, Bangalore (IN); Sumit Basu, Bangalore (IN); Andrea Costa, Lynbrook, NY (US); Christina Lee, Queens, NY (US)

(73) Assignee: Bytemark, Inc., New York, NY (US)

(21) Appl. No.: 17/016,495

(22) Filed: Sep. 10, 2020

Related U.S. Application Data
(60) Provisional application No. 63/070,100, filed on Aug. 25, 2020.

(51) Int. Cl. G06Q 30/02; G06Q 50/30; G06Q 30/00; G06Q 20/04; G07B 15/06

(52) U.S. Cl. CPC G06Q 30/0233; G06Q 50/30; G06Q 30/0185; G06Q 2240/00; G06Q 20/045; G07B 15/063; G06Q 30/0235

(57) ABSTRACT

A transit fare approach that offers a transit agency the ability to cap how many transit passes of a particular type in a given fare cycle would be equivalent of buying a discounted transit product (like a weekly pass, a bi-weekly pass, or a monthly pass). Once this equivalent is reached by a rider, the system automatically gives the rider the corresponding discount pass for free. The free pass remains activated and good for the remainder of the fare cycle. A software module provides a user app for the rider's mobile device and a controller app for a control unit of the transit agency, both of which operate in conjunction with each other to monitor the use of transit passes by the rider to determine when the rider qualifies for the fare cap-based free transit product and subsequently reward the rider with the free use of the appropriate transit product.

### TECHNICAL FIELD

The present disclosure generally relates to electronic ticketing for a transit service. More particularly, and not by way of limitation, particular embodiments of the present disclosure are directed to a system and method in which a user is allowed to avail a transit product for free during the remainder of a given time period once the user's purchases of qualifying transit fares within that time period reach a pre-defined fare cap.

### BACKGROUND

Many transit agencies or transit service providers (for example, a train company, a bus company, or a public transit agency) offer discounts on certain types of transit products (such as a weekly pass, a bi-weekly pass, or a monthly pass) so that the riders pay less than they normally would if they were to buy a series of single-ride or round-trip tickets for those transit products. For example, if a transit rider buys a monthly pass for a transit service for a given month, that monthly pass would cost the rider less than if the rider were to buy individual round-trip or single-ride tickets for the transit service for each day of the month. Similar discounted fares also may be offered for weekly or bi-weekly transit passes, thereby reducing the cost of the corresponding transit service for the riders.

### SUMMARY

Although the above-mentioned discount passes are offered to a transit rider, many riders cannot take advantage of these discounts because of their financial situations. For example, a rider may not have sufficient money at the beginning of a month to purchase a monthly pass. As a result, the rider will end up purchasing less expensive single-ride or round-trip tickets on a day-to-day basis. However, by the end of the month, the total money spent by the rider on such daily purchases will eventually add up to be far more than the cost of the transit agency's monthly pass.

From a customer service point of view, it is desirable to offer a fare option to transit riders that accommodates the riders' need to purchase less-expensive daily tickets/passes, yet rewards such riders with benefits similar to those available to purchasers of more expensive monthly/weekly passes.

As a solution, particular embodiments of the present disclosure provide for a hybrid approach to transit fares that offers a transit agency the ability to cap how many passes of a particular type in a given fare cycle would be equivalent of buying a discounted transit product (such as a weekly pass, a bi-weekly pass, or a monthly pass). Once this equivalent is reached by a passenger (or transit rider), the system may automatically give the user the corresponding discount pass for free. The free pass remains activated and good for the remainder of the fare cycle. For example, if a rider buys 20 single-ride passes before the end of a month, the rider may receive an active monthly pass that will let him/her ride for free until the start of the next month. A Fare Cap (FC) software module as per teachings of the present disclosure may be configured to provide a user app portion for the user's (rider's) mobile device and a controller app portion for a control unit (associated with the transit agency), both of which may operate in conjunction with each other in a client-server configuration to monitor the use of transit passes by a rider to determine when the rider qualifies for the fare cap-based free transit product (or discount pass) and subsequently reward the rider with the free use of the appropriate transit product/discount pass.

In one embodiment, the present disclosure is directed to a method in a control unit associated with a transit system. The method comprises: (i) selecting a qualification count for a transit product, wherein the qualification count specifies a total number of transit passes of a particular type needed to be used by a transit rider in the transit system during a pre-defined time period to qualify for a free use of the transit product; (ii) determining that the transit rider has satisfied the qualification count within the pre-defined time period; and (iii) automatically awarding the transit rider the free use of the transit product for a remainder of the pre-defined time period.

In another embodiment, the present disclosure is directed to a method in a mobile device that is communicatively coupled to a control unit in a transit system. The method comprises: (i) receiving a qualification count for a transit product, wherein the qualification count specifies a total number of transit passes of a particular type needed to be used in the transit system by a transit rider associated with the mobile device during a pre-defined time period to qualify for a free use of the transit product; (ii) generating a usage count for the transit product, wherein the usage count indicates how many transit passes are used by the transit rider during the pre-defined time period; (iii) confirming that the usage count has reached the qualification count during the pre-defined time period; and (iv) informing the transit rider that the transit product is free for use by the transit rider for a remainder of the pre-defined time period.

In a further embodiment, the present disclosure is directed to a control unit in a transit system. The control unit comprises a memory for storing program instructions and a processor coupled to the memory. In the control unit, the processor is operable to execute the program instructions, which, when executed by the processor, cause the control unit to: (i) select a qualification count for a transit product, wherein the qualification count specifies a total number of transit passes of a particular type needed to be used by a transit rider in the transit system during a pre-defined time period to qualify for a free use of the transit product; (ii) determine that the transit rider has satisfied the qualification count within the pre-defined time period; and (iii) automatically award the transit rider the free use of the transit product for a remainder of the pre-defined time period.

The product-based fare capping methodology as per teachings of the present disclosure may provide a simple, convenient, and commercially-viable approach to a fare option that accommodates the riders' need to purchase less-expensive daily tickets/passes, yet rewards such riders with benefits similar to those available to purchasers of more expensive monthly/weekly passes. This rider-friendly approach not only increases a transit agency's (or transit operator's) goodwill among its clients, but also promotes the agency's products without any negative impact on the agency's finances.

### BRIEF DESCRIPTION OF THE DRAWINGS

In the following section, the present disclosure will be described with reference to exemplary embodiments illustrated in the accompanying figures. For ease of discussion, the same reference numbers in different figures indicate similar or identical items.

FIG. 1 illustrates constituent components of a Fare Cap (FC) application according to an exemplary embodiment of the present disclosure.

FIG. 2 depicts an exemplary system for implementing the FC application according to one embodiment of the present disclosure.

FIG. 3 shows an exemplary flowchart illustrating a control unit-based fare capping methodology for a transit product according to one embodiment of the present disclosure.

FIG. 4 shows an exemplary flowchart illustrating a mobile device-based fare capping methodology for a transit product according to one embodiment of the present disclosure.

FIGS. 5-7 show examples of how fare caps may be counted for different transit products and free awards may be generated for a user as per particular embodiments of the present disclosure.

FIGS. 8A-8C provide an exemplary illustration of sample screenshots related to the product-based fare capping methodology as per certain embodiments of the present disclosure.

FIG. 9 is a block diagram of an exemplary mobile device according to one embodiment of the present disclosure.

FIG. 10 depicts a block diagram of an exemplary control unit according to one embodiment of the present disclosure.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “pre-defined,” “single-ride”, “round-trip,” etc.) may be occasionally interchangeably used with its non-hyphenated version (e.g., “predefined,” “single ride”, “round trip,” etc.), and a capitalized entry (e.g., “User Application,” “Operating System,” “Control Unit,” etc.) may be interchangeably used with its non-capitalized version (e.g., “user application,” “operating system,” “control unit,” etc.). Such occasional interchangeable uses shall not be considered inconsistent with each other.

It is noted at the outset that the terms “coupled,” “operatively coupled,” “connected”, “connecting,” “electrically connected,” etc., are used interchangeably herein to generally refer to the condition of being electrically/electronically connected in an operative manner. Similarly, a first entity is considered to be in “communication” with a second entity (or entities) when the first entity electrically sends and/or receives (whether through wireline or wireless means) information signals (whether containing address, data, or control information) to/from the second entity regardless of the type (analog or digital) of those signals. It is further noted that various figures (including component diagrams) shown and discussed herein are for illustrative purpose only, and are not drawn to scale.

The terms “first,” “second,” etc., as used herein, are used as labels for nouns that they precede, and do not imply any type of ordering (e.g., spatial, temporal, logical, etc.) unless explicitly defined as such. Furthermore, items or features appearing in different figures may be identified using the same reference numeral for ease of discussion. However, such identification does not imply that the commonly-referenced items/features are identical across all embodiments.

In the discussion herein, the terms “passenger”, “transit rider”, “rider”, and “user” may be used interchangeably merely for ease of description. Similarly, the terms “transit agency”, “transit operator”, and “transit service provider” may be used interchangeably to refer to an entity such as a train company, a bus company, a public transit agency, a ferry operator, and the like, which offers fare-based transit services to the riders.

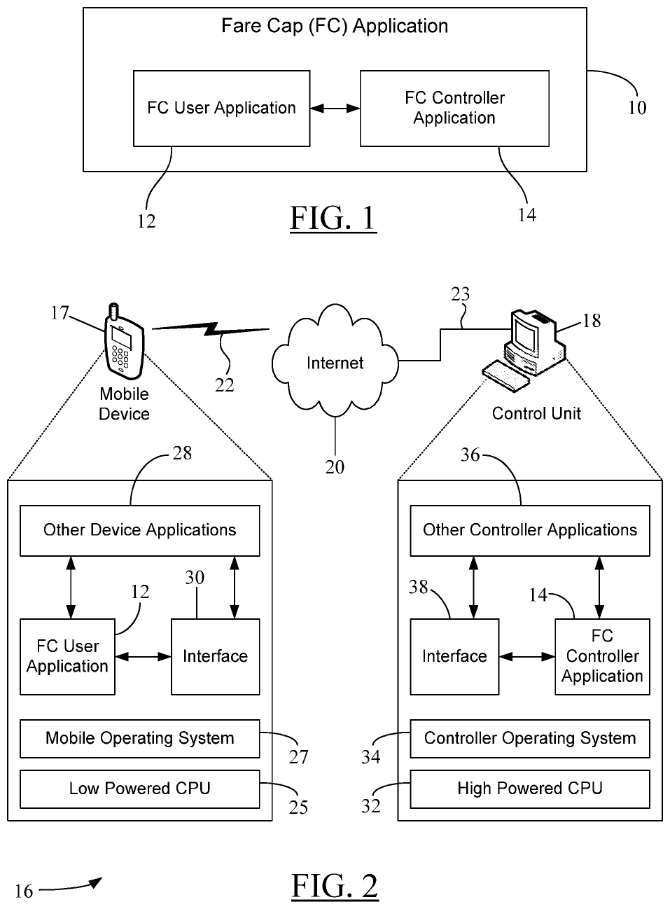

FIG. 1 illustrates constituent components of a Fare Cap (FC) application 10 according to an exemplary embodiment of the present disclosure. The FC application 10 may be a software module having various distributed data processing functionalities discussed later below with reference to FIGS. 2-10. Some portion of data processing or computations may be performed locally in a mobile device whereas some other portion of data processing may be performed on a control unit. The FC application 10 according to one embodiment of the present disclosure may include a FC User Application (user app) component 12 and a FC Controller Application (controller app) component 14. In particular embodiments, the user app 12 and the controller app 14 may interact with each other in a client-server configuration. The user app and the controller app components may be in bi-directional communication (as discussed below with reference to FIG. 2) with each other, and may together facilitate the transit product-based fare capping functionality as discussed later. It is noted here that, for ease of discussion, a computer software, program code or module may be referred to as “performing,” “accomplishing,” or “carrying out” a function or process. However, it is evident to one skilled in the art that such performance may be technically accomplished by a processor when the software or program code is executed by the processor. The program execution would cause the processor to perform the tasks or steps instructed by the software to accomplish the desired functionality or result. However, for the sake of convenience, in the discussion below, a processor or software component may be referred to interchangeably as an “actor” performing the task or action described, without technically dissecting the underlying software execution mechanism.

FIG. 2 depicts an exemplary system 16 for implementing the FC application 10 according to one embodiment of the present disclosure. The system 16 may include a mobile device 17 that is in communication with a control unit 18 via a communication network 20. In one embodiment, the communication network 20 may be a Transmission Control Protocol/Internet Protocol (TCP/IP) based network such as, for example, the Internet. In another embodiment, the communication network 20 may be a different type of packet-switched network. The mobile device 17 may send/receive content from the control unit 18 through its wireless connection—as illustrated by a wireless link 22—with the Internet 20. On the other hand, in some embodiments, the control unit 18 may be connected to the Internet 20 via a wired connection 23, such as an Ethernet connection. In other embodiments, the control unit 18 may communicate with the Internet 20 via a wireless connection (not shown) or a combination of wired and wireless connections. The FC user app 12 may reside in the mobile device 17, whereas the FC controller app 14 may reside at the control unit 18 as shown in FIG. 2. It is noted here that the terms “mobile device,” “mobile handset,” “wireless handset,” and “User Equipment (UE)” may be used interchangeably hereinbelow to refer to a wireless communication device that is capable of voice and/or data communication. Some examples of such mobile handsets include cellular telephones or data transfer equipments, tablets, and smartphones (e.g., iPhone™, Android™, Blackberry™, etc.). It is observed here that, for ease of discussion, the control unit 18 is shown as a separate device or apparatus. However, the control unit 18 may not have to be a separate computing unit (in hardware or software form) dedicated to carry out the product-based fare capping functionality. In one embodiment, the functionality of the control unit 18 may be implemented in an already-existing physical computing/data processing unit or (non-physical) server software (not shown) at a transit station or elsewhere within a transit system or at a remote location where data related to the transit system (or transit network) may be processed. In another embodiment, the functionality of the control unit 18 may be accomplished using multiple different units in a transit system or a cloud-based computing configuration.

As shown in FIG. 2, the UE 17 may include, inside its housing (not shown), a relatively low-powered Central Processing Unit (CPU) 25 executing a mobile operating system (or mobile OS) 27 (e.g., Symbian™ OS, Palm™ OS, Windows Mobile™, Android™ Apple iOS™, etc.). Because of the battery-powered nature of mobile handsets, the CPU 25 may be designed to conserve battery power and, hence, may not be as powerful as a full-functional computer or server CPU. As further shown in FIG. 2, in addition to the user app 12, the UE 17 may also have one or more mobile applications 28 resident therein. These mobile applications 28 are software modules that may have been pre-packaged with the handset 17 or may have been downloaded by a user into the memory (not shown) of the UE 17. Some mobile applications 28 may be more user-interactive applications (e.g., a mobile game of chess to be played on the UE 17, a face recognition program to be executed by UE 17, etc.), whereas some other mobile applications may be significantly less user-interactive in nature (e.g., UE presence or location tracking applications, a transit pass manager application). The mobile applications 28 as well as the user app 12 may be executed by the processor 25 under the control of the mobile operating system 27. As also shown in FIG. 2, the UE 17 may further include an interface unit 30 to facilitate UE's wireless communication with the control unit 18 via the Internet 20. In particular embodiments, the interface unit 30 may also support other types of wireless connections such as, for example, a cellular network connection, a Wi-Fi connection, and the like. The applications 12, 28 may utilize the wireless interface 30 as needed.

The user app 12 may be configured to run on a variety of mobile devices—Android-based, Apple iOS-based, or any other mobile operating system-based. In particular embodiments, the mobile device 17 may support downloadable applications and may include a User Interface (UI) to facilitate various tasks in support of the product-based fare capping. Such tasks may include, for example, display of a user's ticket usage data, monitoring a user's progress towards a fare cap, intimation of the user's qualification to receive a free transit pass upon reaching the requisite fare cap, and the like.

In the embodiment of FIG. 2, the control unit 18 is shown to include a relatively high powered CPU 32 executing an operating system 34 (e.g., Windows™, Mac™ OSX, Linux, etc.). In addition to the controller app 14, the control unit 18 also may store in its memory (not shown) other controller-specific applications 36 such as, for example, an application that facilitates Ethernet-based communication with an entry gate system at a transit station, an application that facilitates communication with a “people counting” device or security camera network, an application that interacts with a backend system, and the like. The control unit 18 may be associated with a transit system (such as, for example, a railway system, a bus-based public transport network, and the like) and may communicate with the UE 17 via its own interface unit 38. The interface units 30, 38 may transfer data or information between the mobile device 17 and the control unit 18 via the Internet 20 using appropriate data transfer mechanisms. Thus, in operation, a UE-generated signal may be wirelessly sent (using the interface 30) to the Internet 20 for eventual delivery to the control unit 18 for further processing by its CPU 32. Any response or other signal from the control unit 18 can be provided to the interface unit 38 and eventually delivered to UE's wireless interface 30 (and, hence, to the UE's processor 25 for further processing) via the combination of the Internet 20 and the wireless link 22. In particular embodiments, the interface unit 38 also may support wireless connections such as, for example, a cellular network connection, a Wi-Fi connection, and the like. The applications 14, 36 may utilize the control unit's interface 38 as needed. It is observed here that, in particular embodiments, the mobile device 17 and/or the control unit 18 may be coupled to other networks (not shown) via a wired or wireless connection (whether circuit-switched or packet-switched). Such networks may be voice networks, data networks, or both, and may include, for example, a cellular network, the Internet, a Local Area Network (LAN), a Public Land Mobile Network (PLMN), and the like.

In particular embodiments, the controller unit 18 may be a computer such as, for example, a laptop or a desktop computer, a mobile device, a tablet computer, a single-board computer, or a modular controller such as a Raspberry Pi™ or Arduino™ unit. As discussed in more detail later with reference to FIG. 10, the control unit 18 may support some or all of the following capabilities: wired or wireless connectivity, Universal Serial Bus (USB) connectivity, non-volatile storage such as flash or disk storage, volatile storage using Random Access Memory (RAM) modules, video or Liquid Crystal Display (LCD) display, and a data input device such as a keyboard. It is noted here that, in certain embodiments, there may be more than one control unit 18 installed within a transit system, such as, for example, when different controller units are associated with different transit regions. Generally, the number of controller units may be implementation-specific. In the discussion herein, the terms “control unit” and “controller unit” may be used interchangeably merely for ease of description.

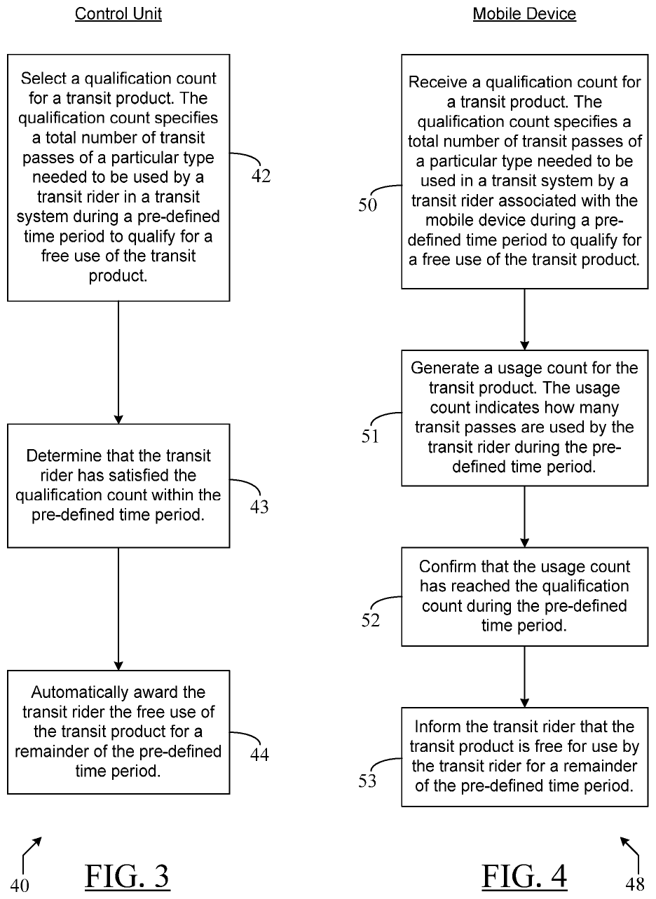

FIG. 3 shows an exemplary flowchart 40 illustrating a control unit-based fare capping methodology for a transit product according to one embodiment of the present disclosure. Various operational tasks shown in FIG. 3 may be performed by the control unit 18 (which is associated with a transit system as noted before) when the controller application 14 (and other relevant program code) is executed by the CPU 32. More generally, the control unit 18 performing the steps shown in FIG. 3 may include in hardware and/or software the functionality of the FC controller app 14. It is noted here that in the flowchart 40 in FIG. 3 (and also in the flowchart 48 in FIG. 4), each block represents one or more tasks that can be implemented in hardware, software, or a combination thereof. In the context of software, the blocks represent computer-executable instructions that, when executed by one or more processors, cause the processors to perform the recited tasks. Generally, computer-executable instructions include routines, programs, objects, modules, components, data structures, and the like that perform particular functions or implement particular abstract data types. The order in which the blocks are described is not intended to be construed as a limitation, and any number of the described tasks can be combined in any order and/or in parallel to implement the process shown in the flowchart 40 (as well as that in the flowchart 48). For discussion purpose, the tasks in the flowcharts 40, 48 are described with reference to the system configuration of FIG. 2 as described above, although other models, frameworks, systems and environments may be used to implement these tasks.

Initially, at block 42, the control unit 18 may select a qualification count for a transit product (which may be a weekly pass, a bi-weekly pass, a monthly pass, and the like, as noted before). The qualification count may specify the total number of transit passes of a particular type (for example, a single-ride pass, a round-trip pass, or a multi-ride pass) needed to be used by a transit rider in the transit system during a pre-defined time period (such as the earlier-mentioned fare cycle) to qualify for the free use of the transit product. In certain embodiments, the control unit 18 may receive the qualification count from an external source, such as a human operator associated with the transit agency or a data processing system or computing unit in the transit system. In that case, at block 42, the control unit 18 may simply select the received qualification count. In other cases, FC controller application 14 in the control unit 18 may enable the control unit 18 to select an appropriate qualification count for a specific transit product (for example, from a set of pre-programmed qualification counts and corresponding transit products). In some embodiments, the transit product at issue may be identified by the control unit 18 when the user's mobile device 17 (more specifically, the FC user app 12) reports the user's purchase and activation(s) of a particular type of transit passes (preferably in an electronic form).

It is noted here that, in particular embodiments, a user may purchase an electronic ticket for a transit service (for example, a bus service, a train service, a ferry service, and the like). The terms “electronic ticket” and “digital pass” may be used interchangeably for ease of discussion. In any event, the term “electronic ticket,” as used herein, may include a single digital transit ticket/pass (for example, a single-ride pass) or a set of digital tickets/passes depending on the user transaction. The electronic ticket—whether issued as a single digital pass or multiple digital passes—may be used in a transit system that supports hands-free fare validation by allowing a passenger to simply walk through a fare gate at a transit station “hands free” so long as the passenger has a valid, active ticket on his/her mobile device. Such a transit system is discussed in the commonly-owned U.S. Pat. No. 10,375,573. The user may be a transit passenger who is availing a transit service in the transit system. A transit vehicle (such as a bus or a train), on the other hand, is a vehicle that is associated with a specific transit service and that makes stops at stations in a transit system. A transit station is a location at which a transit vehicle makes regular stops. It is understood that a transit system may include a number of transit vehicles, transit stations, data sensors, and other system components to successfully operate the transit network for passenger mobility. In some embodiments, the transit system may support mobility or transport of non-passenger items as well, such as specific goods or packages.

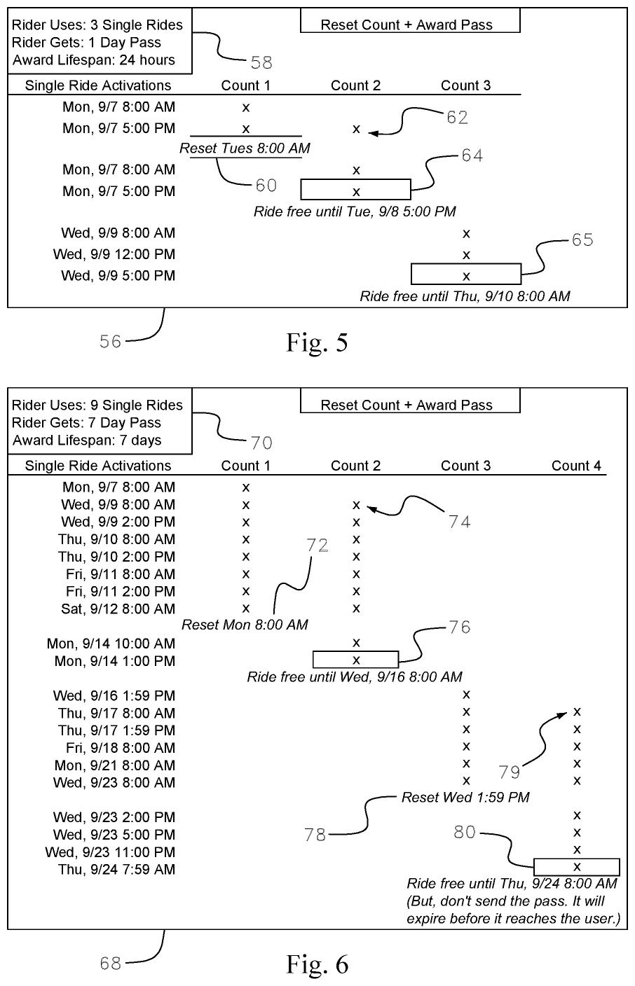

Referring again to FIG. 3, at block 43, the control unit 18 may determine that the transit rider has satisfied the qualification count within the pre-defined time period. Consequently, the control unit 18 may automatically reward the transit rider the free use of the applicable transit product for the remainder of the pre-defined time period (or fare cycle), as noted at block 44. For example, if the qualification count for a monthly pass is 20 single-ride passes, and if a user purchases 20 such passes before the month ends, then the control unit 18 may grant the user an active monthly pass that will let the user ride the appropriate transit service for free until the start of the next month. Additional discussion of how fare caps may be counted for different transit products and free awards may be generated for a user is provided later with reference to the examples in FIGS. 5-7.

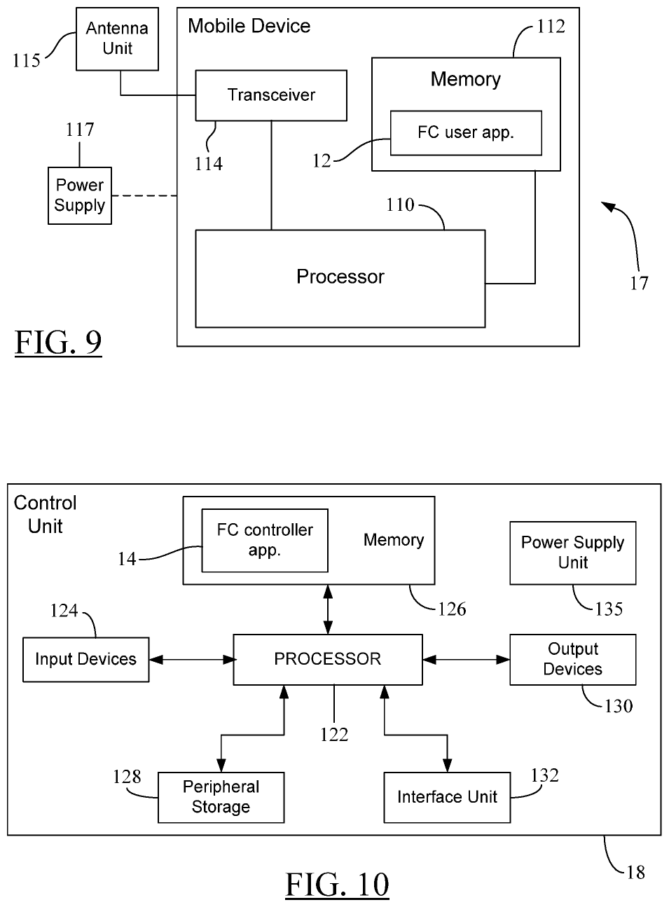

FIG. 4 shows an exemplary flowchart 48 illustrating a mobile device-based fare capping methodology for a transit product according to one embodiment of the present disclosure. Various operational tasks shown in FIG. 4 may be performed by the mobile device 17 when the user app 12 (and other relevant program code) is executed by the CPU 25. Initially, at block 50, the mobile device 17 may receive a qualification count for a transit product (such as a weekly pass, a bi-weekly pass, a monthly pass, and the like, as noted before). The qualification count may specify the total number of transit passes of a particular type (for example, a single-ride pass, a round-trip pass, or a multi-ride pass) needed to be used in the transit system by the transit rider associated with the mobile device 17 during a pre-defined time period (or fare cycle) to qualify for the free use of the transit product. In particular embodiments, the mobile device 17 may receive the qualification count from the control unit 18. In other embodiments, the user app 12 may monitor the user's purchase and activation(s) of a particular type of transit passes and select an appropriate qualification count for a specific transit product (for example, from a set of pre-programmed qualification counts and corresponding transit products) based on the information about electronic tickets/passes purchased by the user. In one embodiment, the tickets/passes may be stored in a memory of the device 17 (such as the memory 112 in FIG. 9) and made accessible to the user (through the user app 12) when needed.

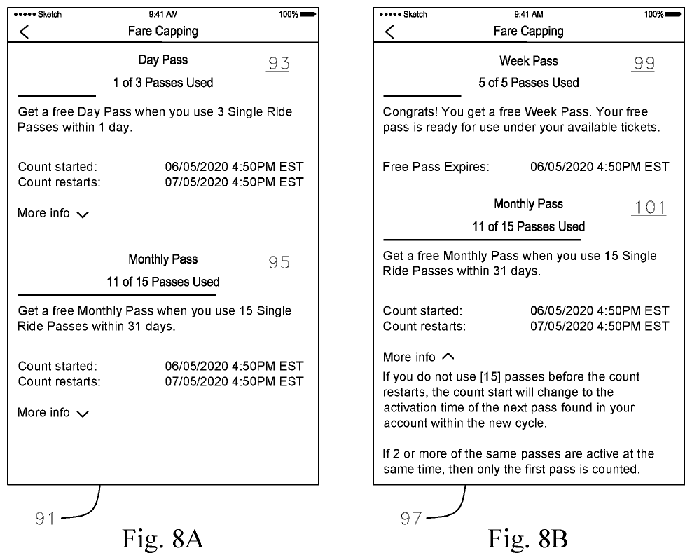

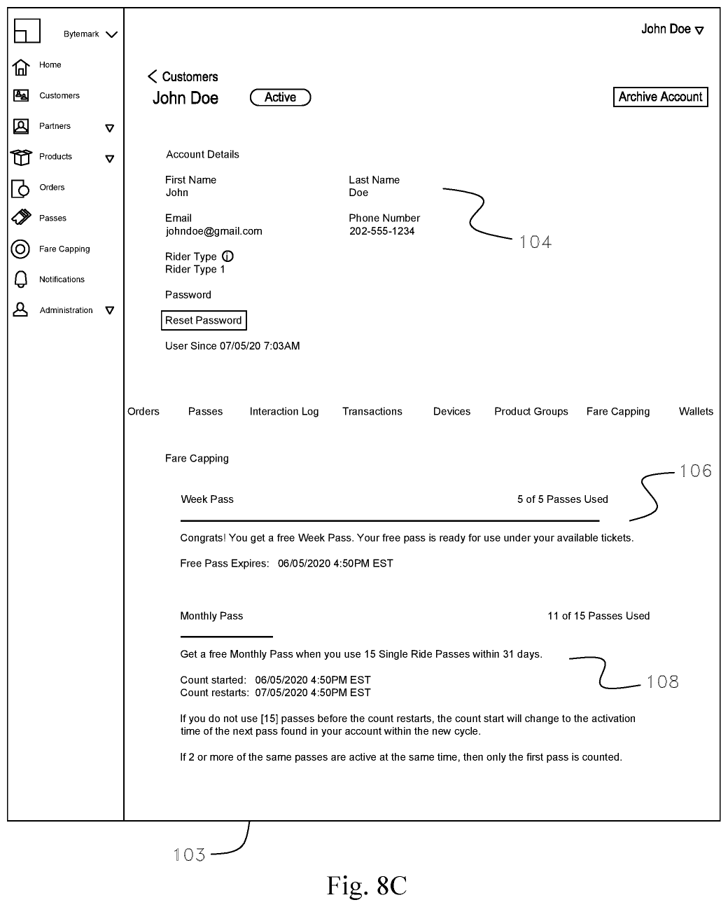

At block 51, the mobile device 17 may generate a usage count for the transit product. The usage count may indicate how many transit passes are used by the transit rider/user during the pre-defined time period. As shown in the exemplary embodiments of FIGS. 8A-8C (discussed later), the mobile device 17 also may display the qualification count and the usage count on a display screen of the device 17. In particular embodiments (discussed later with reference to FIGS. 5-7), the user app 12 in the mobile device 17 may increment the usage count for every transit pass that is activated by the user within a pre-determined time limit and at a time instant different from other transit passes activated within the pre-determined time limit. The user app 12 also may increment the usage count for every transit pass that expires due to non-activation by the user within the pre-determined time limit. At block 52, the mobile device 17 may confirm that the usage count has reached the qualification count during the pre-defined time period (or fare cycle).

In one embodiment, the user app 12 in the mobile device 17 may trigger the device 17 to transmit the usage count to the control unit 18 whenever the usage count is updated, and receive an intimation from the control unit 18 that the transit rider has satisfied the qualification count. In that case, the control unit 18 may monitor the usage count and verify its accuracy (for example, to avoid fraud) before approving it as valid. In certain embodiments, in addition to or in place of the mobile device 17, the control unit 18 itself may generate or maintain the usage count based on the user app's 12 reporting of the transit passes used by the transit rider, increment the usage count (in a manner similar to that discussed above) based on the communication with the user app 12, and confirm that the usage count has reached the qualification count during the applicable fare cycle.

As a result of the confirmation at block 52, the mobile device 17 may inform the transit rider/user that the relevant transit product is free for use by the rider for the remainder of the pre-defined time period (block 53). In one embodiment, the mobile device 17 may provide a visible notification of the free use of the transit product, as shown, for example, in FIG. 8B (discussed later). Alternatively or additionally, in another embodiment, the mobile device 17 may provide an audible and/or vibratory notification of the free use through a chime, ringtone, vibration, and the like.

FIGS. 5-7 show examples of how fare caps may be counted for different transit products and free awards may be generated for a user as per particular embodiments of the present disclosure. In particular embodiments, the tasks discussed with reference to FIGS. 5-7 may be performed by the control unit 18 under operative control of the FC controller app 14. In other embodiments, these tasks also may be performed locally by the FC user app 12 in the user's mobile device 17. However, in some embodiments, it may be desirable (for example, to avoid fraud) to allow only the control unit 18 to grant and approve the free awards to users. In any event, because the FC user app 12 and the FC controller app 14 may be in real-time communication with each other in a client-server manner, any information updates (for example, updates in the qualification or usage counts) or user activity monitored and/or tracked (for example, purchase of electronic tickets, use of the tickets, and the like) by one of these software modules may be readily reported to (or synchronized with) the other software module so that the information displayed to the user on the mobile device 17 is the same as that displayed to a customer service person operating the control unit 18, as shown, for example, in FIGS. 8B and 8C. It is noted here that the terms “server” and “client” are used herein for ease of discussion and to more clearly explain the execution of the FC application 10 (FIG. 1) and its interactions with the mobile device 17 and the control unit 18 (FIG. 2). However, this usage does not necessarily imply that the client-server based model is the only way to implement the functionality of the FC app 10 as per teachings of the present disclosure. Furthermore, in certain aspects, the server-based control unit 18 may function as a “server,” whereas in some other respects, it may not function as a server. Similarly, in certain aspects, the mobile device 17 may function as a “client” of the server 18, whereas in some other respects, it may not function as a client system.

A transit agency may use the FC application 10 to create many different types of fare caps like a “Daily Cap,” a “Weekly Cap,” a “Monthly Cap”, and so on. Each such “cap” may be defined by the following three criteria: (i) what type of the transit pass/ticket the rider needs to use to qualify for the respective fare cap, (ii) how many of such transit passes (herein referred to as the “qualification count”) the rider needs to use to qualify for the fare cap, and (iii) what benefit (or free award) the rider receives when they qualify. In certain embodiments, a user may purchase electronic tickets from the control unit 18 using the FC user app 12. As mentioned before, an electronic ticket (which may be received from the control unit 18) may not be a single ticket, but rather may be a group of digital passes for the corresponding transit service offered by a transit company. For example, a passenger may purchase four (4) single-ride, daily passes for a train service in a single transaction. In that case, the control unit 18 may send the four digital passes bundled together as an “electronic ticket.” The following are some of the different types of tickets/passes that may be offered in case of a bus service as an example: (i) a basic (or regular-priced) ticket for a single ride, (ii) a basic daily pass, (iii) a basic monthly pass, (iv) a basic semi-monthly pass (from 1st of the month through the 15th of the month), (v) a basic semi-monthly pass (from the 16th of the month through the end of the month), (vi) a discounted single ride ticket (for example, for senior citizens, students, transit company employees, individuals with disabilities, and the like, or for travel during off-peak time periods), (vii) a discounted daily pass, and (viii) a discounted monthly pass.

In the context of FIGS. 5-7, a single ticket or pass may be considered “used” at a time instant when one of the following use event occurs after its purchase: (i) the user (or transit rider) activates the specific transit pass, or (ii) the transit pass expires due to non-activation by the rider within a pre-determined time limit (for example, within 24 hours of purchase, or within one week of purchase, and the like). In certain embodiments, passes credited to a user's account (by someone else), sent to another user (for example, a family member or a friend), or distributed through business partnerships may not increase the applicable fare cap count (or usage count). Similarly, passes spoiled (but not expired) or refunded may not reduce the fare cap count (or usage count).

Furthermore, if two or more passes of the same type are active at the same time, then only the first-activated pass may be counted towards the fare cap count. For example, a teacher on a field trip with 20 students activating 21 tickets together will not receive 21 “usage counts” towards the fare cap; only the first activation counts and teacher will receive only one usage count.

In particular embodiments, the fare cycle during which a rider needs to complete all of his/her uses—in order to qualify for the free award—may be defined by the cycle of the awarded product itself. For example, a monthly pass might have the first (1st) of the month lifespan, which means that on the first of a given month, the qualification count starts over and any pass awarded from the prior month expires.

Thus, in the context of FIGS. 5-7, the activation time of a qualifying ticket/pass may be looked at when determining if the ticket should result in an award. If two or more tickets of the same type get activated at the same time or if a pass is activated when a pass of the same type is still active, then only the first ticket/pass may be counted towards the fare cap. When the rider makes the final qualifying purchase, and activates and uses that ticket/pass, the rider may electronically receive the awarded product (or award pass) on the user's mobile device 18, for example, from the control unit 18. In particular embodiments, the award pass may not be sent to the user until the qualifying ticket expires. The rider may receive an email notification and/or other alert (visual and/or audible) on a User Interface (UI) of the FC user app 12, and may be able to see the awarded pass in the rider's “ticket wallet” (online or on the mobile device 17 under the user app 12) or other similar facility. The awarded pass may be retroactively activated to the start of the fare cycle and, as noted before, it may expire as per the awarded product's lifespan (for example, at the end of the fare cycle). In certain embodiments, if the award pass is granted (or if the rider qualifies for an award pass), but the pass will expire before the rider could use it, then it may not be sent to the rider, as shown in FIG. 6 (discussed below).

Referring now to the example in table 56 in FIG. 5, the award criteria listed in the block 58 specify that if a rider uses three (3) single-ride tickets/passes (which is the “qualification count”), the rider may receive a 1-day pass (the awarded product) for free. The free award (here, a 1-day pass) has the lifespan of 24 hours from the start of the fare cycle (as determined by the earliest-activated qualifying pass). As a result, the usage count may be reset after 24 hours from the earliest-activated qualifying pass. Therefore, as noted at reference numeral “60”, the first usage count (denoted as the “Count 1” column in the table 56) for the rider will be reset 24 hours from the earliest activation—that is, on Tuesday (September 8 date) at 8 AM, because the earliest-activation is on Monday (September 7 date) at 8 AM. In case of the multiple activations at arrow 62 (referring to the activations of two single-ride passes on Monday (September 7 date) at 5 PM), only one activation may count towards the rider's new usage count (denoted as the “Count 2” column in the table 56). Now the rider may need two more activations within the fare cycle (here, 24 hours from the Monday, 5 PM activations at arrow 62) to meet the qualification count of 3 single-rides within 24 hours. Therefore, when the rider activates the single-ride pass at block 64 in the table 56, the rider would qualify for the award product (here, a 1-day pass for unlimited free rides). As noted below block 64, the award product will expire 24 hours after the earliest-activated qualifying ticket in the fare cycle (here, 24 hours from the 5 PM activation on Monday (September 7 date)). The usage count may again reset thereafter. The third usage count (denoted as the “Count 3” column in the table 56) for the rider will start upon the next activation of a single-ride ticket on Wednesday (September 9 date) at 8 AM, which will also determine the lifespan of the awarded pass, as noted below block 65 in the table 56. The usage count may reset thereafter the award-determination process of FIG. 5 may repeat as discussed above.

Referring now to the example in table 68 in FIG. 6, the award criteria listed in the block 70 specify that if a rider uses nine (9) single-ride tickets/passes (which is the “qualification count”), the rider may receive a 7-day pass (the awarded product) for free. The free award (here, a 7-day pass) has the lifespan of 7 days from the start of the fare cycle (as determined by the earliest-activated qualifying pass). As a result, the usage count may be reset after 7 days from the earliest-activated qualifying pass. Therefore, as noted at reference numeral “72”, the first usage count (denoted as the “Count 1” column in the table 68) for the rider will be reset 7 days from the earliest activation—that is, on Monday (September 14 date) at 8 AM, because the earliest-activation is on Monday (September 7 date) at 8 AM. In case of the multiple activations at arrow 74 (referring to the activations of two single-ride passes on Wednesday (September 9 date) at 8 AM), only one activation may count towards the rider's new usage count (denoted as the “Count 2” column in the table 68). Now the rider may need eight (8) more activations within the fare cycle (here, 7 days from the Wednesday (September 9 date), 8 AM activations at arrow 74) to meet the qualification count of 9 single-rides within 7 days. Therefore, when the rider activates the single-ride pass at block 76 in the table 68, the rider would qualify for the award product (here, a 7-day pass for unlimited free rides). As noted below block 76, the award product will expire 7 days after the earliest-activated qualifying ticket in the fare cycle (here, 7 days from the 8 AM activation on Wednesday (September 9 date)). The usage count may again reset thereafter. The third usage count (denoted as the “Count 3” column in the table 68) for the rider will start upon the next activation of a single-ride ticket on Wednesday (September 16 date) at 1:59 PM and the fare cycle would reset after 7 days—that is, on Wednesday (September 23 date) at 1:59 PM, as noted at reference numeral “78.”

In case of the multiple activations at arrow 79 (referring to the activations of two single-ride passes on Thursday (September 17 date) at 8 AM), only one activation may count towards the rider's new (fourth) usage count (denoted as the “Count 4” column in the table 68). Now the rider may need eight (8) more activations within the fare cycle (here, 7 days from the Thursday (September 17 date), 8 AM activations at arrow 79) to meet the qualification count of 9 single-rides within 7 days. Therefore, when the rider activates the single-ride pass at block 80 in the table 68, the rider would qualify for the award product (here, a 7-day pass for unlimited free rides). As noted below block 80, the award product will expire 7 days after the earliest-activated qualifying ticket in the fare cycle (here, 7 days from the 8 AM activation on Thursday (September 17 date)). In other words, the award pass is retroactively activated to the start of the qualifying fare cycle. However, as mentioned before and as also noted below block 80, the award product may not be sent to the user/rider because the 7-day award pass will expire (at 8 AM on Thursday (September 24 date)) before the rider could use it. The usage count may again reset thereafter and the award-determination process of FIG. 6 may repeat as discussed above.

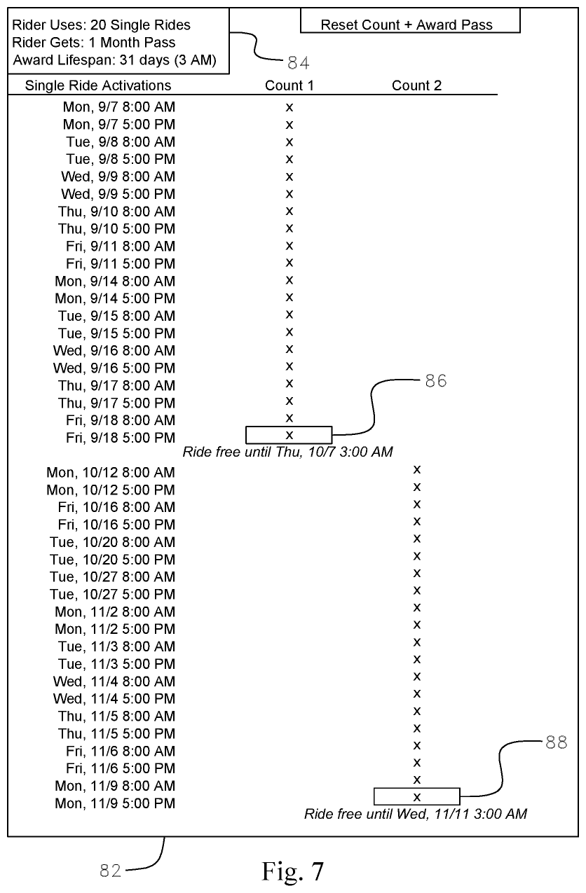

Referring now to the example in table 82 in FIG. 7, the award criteria listed in the block 84 specify that if a rider uses twenty (20) single-ride tickets/passes (which is the “qualification count”), the rider may receive a 1-month pass (the awarded product) for free. The free award (here, a 1-month pass) has the lifespan of 31 days with the expiry on a fixed time (here, at 3 AM on the 31st day) regardless of the time of the start of the fare cycle (as determined by the earliest-activated qualifying pass). As a result, the usage count may be reset at 3 AM on the 31st day from the date of the earliest-activated qualifying pass. In the table 82, the first usage count (denoted as the “Count 1” column in the table 82) starts when the rider activates the first single-ride pass on Monday (September 7 date) at 8 AM. The rider meets the qualification count of 20 single-ride activations within 31 days when the rider activates the 20^{th} pass at block 86 in the table 82. The rider then qualifies for the award product (here, a 1-month pass for unlimited free rides), which will expire at 3 AM on the 31^{st} day after the date of the earliest-activated qualifying ticket in the fare cycle. Therefore, as noted below block 86, the award pass will expire on Thursday (October 7 date) at 3 AM. The usage count may again reset thereafter. The second usage count (denoted as the “Count 2” column in the table 82) for the rider will start upon the next activation of a single-ride ticket on Monday (October 12 date) at 8 AM. The 31-day lifespan of the next award will be retroactively determined from this start date of the fare cycle. Therefore, as noted below block 88 in the table 82, the next free award will expire at 3 AM on Wednesday (November 11 date). The usage count may reset thereafter the award-determination process of FIG. 7 may repeat as discussed above.

It is noted that different fare cap scenarios similar to the examples in FIGS. 5-7 may be implemented through the FC app 10 as desired. For example, the pre-defined time period (or fare cycle) mentioned at block 42 in FIG. 3 and at block 50 in FIG. 4 may be one of the following in particular embodiments: (i) 24 hours from an earliest-used transit pass (as shown in the exemplary embodiment of FIG. 5), (ii) a fixed time of a day occurring after a day of the earliest-used transit pass (as shown in the exemplary embodiment of FIG. 7), (iii) seven days from the earliest-used transit pass (as shown in the exemplary embodiment of FIG. 6), (iv) a fixed time on the first day of a month occurring after a month of the earliest-used transit pass, (v) a fixed time of an n^{th} day (for example, 5^{th} day, 7^{th} day, and the like) from the earliest-used transit pass, or (vi) a fixed time of an n^{th} day from the earliest-used transit pass, where “n” has a value selected from the set consisting of the values {7, 30, 31} (meaning the 7^{th} day, the 30^{th} day, or the 31^{st} day).

In certain embodiments, the FC controller app 14 may present a UI (not shown) to a customer service representative operating the control unit 18 to allow the representative to set a “rider type” flag for a transit rider that may identify the rider as a particular type of rider. For example, the “rider type 1” flag may be tagged to commuters, the “rider type 2” flag may be tagged to senior citizens and disabled riders, the “rider type 3” flag may be tagged to tourists, the “rider type 4” flag may be tagged to school children and teachers, and so on. In particular embodiments, the rider types may be customizable by the service personnel using a customer service screen of the UI provided by the FC controller app 14. In certain embodiments, the “rider type” flag also can be tagged to a specific fare cap. In other words, certain fare caps or product awards can be restricted to be available only for certain types of riders. This allows only riders of that specific “rider type” to be able to participate in the fare cap tagged to the same rider type. Therefore, in particular embodiments, the qualification count may be based on the type of the transit rider and the control unit 18 may select the appropriate qualification count based on an indication received from a customer service representative (or some other source) regarding the “rider type” of the transit rider.

In particular embodiments, the a transit rider may initially have to deploy the FC user app 12 on his/her mobile device 17 to participate in the fare cap-based transit awards. As discussed below with reference to the exemplary screenshots in FIGS. 8A-8B, the FC user app 12 may provide a UI on the mobile device 17 to allow the user to view the user's progress towards the appropriate free product. The user app 12 also may manage the electronic ticket(s) or digital pass(es) in a user account within the FC user app 12. In particular embodiments, the user may use the FC user app 12 or other ticket-purchasing app in the mobile device 17 to purchase and receive these tickets from the control unit 18 (or some other ticketing entity in the transit system). The FC user app 12 may further allow the user to see which transit tickets are electronically stored on the user's mobile device 17. In some embodiments, if the user has setup an online account with the transit service operator, the FC user app 12 may allow the user to link the current purchases to that account, for example, for managing user's annual transit expense, or monitoring the user's travel pattern, and the like.

In one embodiment, the control unit's 18 Uniform Resource Locator (URL) link (or web address) may be embedded in the FC user app 12 to enable the app 12 to connect to the control unit 18 (and, hence, to the FC controller app 14), for example, via the Internet 20 (FIG. 2), so as to track the usage/redemption of the ticket(s) in the transit system. As mentioned earlier, in particular embodiments, the FC user app 12 and the FC controller app 14 may be in real-time communication with each other in a client-server manner so that the information or updates displayed to the user on the mobile device 17 may be the same as that displayed to a customer service person operating the control unit 18. It is noted that, in some embodiments, the bi-directional messaging between the FC user app 12 and the FC controller app 14 may be based on the Hypertext Transfer Protocol (HTTP) or the Hypertext Transfer Protocol Secure (HTTPS). In other embodiments, different protocols or messaging schemes may be used to effectuate communication related to the product-based fare capping as per teachings of the present disclosure.

FIGS. 8A-8C provide an exemplary illustration of sample screenshots related to the product-based fare capping methodology as per certain embodiments of the present disclosure. The screenshots in FIGS. 8A and 8B may be generated on a display screen of the mobile device 17 by the FC user app 12, whereas the screenshot in FIG. 8C may be a UI generated on a display screen of the control unit 18 by the FC controller app 14. The screenshot 91 in FIG. 8A illustrates an exemplary “Fare Cap” screen of the FC user app 12 depicting a progress chart of the rider towards one or more award products so that the rider can see how close they are at a given point to earning the award. As shown in the example of FIG. 8A, the portion 93 informs the rider that the rider has used only one (1) of the 3 passes required to qualify for a free daily pass, whereas the portion 95 shows that the rider has used 11 of the 15 qualifying passes for a free monthly pass. Each display portion also may provide instructions to the rider as to how to qualify for the corresponding free transit product, as well as information about the date and time of the start and end of the applicable fare cycle.

The screenshot 97 in FIG. 8B illustrates another exemplary “Fare Cap” screen of the FC user app 12 depicting a portion 99 that visually informs the rider that the rider has met the qualification count for a weekly pass, whereas the portion 101 shows that the rider has used 11 of the 15 qualifying passes for a free monthly pass (similar to the information conveyed by the portion 95 in FIG. 8A). The display portion 99 also informs the rider when the free pass would expire. As in case of the portion 95 in FIG. 8A, the display portion 101 in FIG. 8B also provides instructions to the rider as to how to qualify for the corresponding free transit product, as well as information about the date and time of the start and end of the applicable fare cycle. In particular embodiments, in addition to the visible notification of the display portion 99, the FC user app 12 also may provide an audible notification of the product award, for example, in the form of a specific sound or tone.

In particular embodiments, the transit rider may select in advance which fare cap or fare caps (for example, for a free daily pass, a free monthly pass, a free weekly pass, and the like) the rider wishes to participate in. Such selection may be made via the UI (not shown) of the FC user app 12 or in an online user account (which may be linked to or managed by the FC user app 12 and/or the FC controller app 14 in some embodiments). Furthermore, in case of a ticket being qualified for multiple fare caps, when a rider activates the qualifying ticket, the rider may use the FC user app 12 to apply the activated ticket to one of the fare caps as desired by the rider. In other embodiments, the same ticket may be automatically applied to multiple fare caps by the user app 12. However, in that case, the rider may be allowed to select only one award even if the rider qualifies for multiple awards. If the rider redeems for one award (for example, a free weekly pass) while still waiting to meet the qualification count for another award (for example, a free monthly pass), the tickets counted for the redeemed award may be subtracted from the usage count accumulated for the pending award (here, the monthly pass) and the rider may need to purchase and activate additional tickets to qualify for the pending award.

FIG. 8C shows an exemplary screenshot 103 of a customer support screen of the FC controller app 14 for a specific customer. A customer service agent operating the control unit 18 may have access to the information in the screenshot 103, as mentioned before. The customer-specific account details (such as the name of the customer, contact details of the customer, the “rider type” assigned to the customer, and the like) may be displayed in the top portion 104, whereas the customer's progress chart for one or more fare caps may be displayed below the portion 104. In the exemplary screenshot 103, the portion 106 is substantially identical to the portion 99 in FIG. 8B, both of which show that the customer has met the qualification count for a weekly pass. Similarly, the portion 108 in FIG. 8C is substantially identical to the portion 101 in FIG. 8B, both of which show that the customer has used 11 of the 15 qualifying passes for a free monthly pass. Each portion 106, 108 also may provide relevant details (similar to the information shown in the display portions 99 and 101) for the corresponding fare cap for review/reference by the customer service agent.

As discussed before, the real-time exchange of information between the FC user app 12 and the FC controller app 14 may facilitate display of the substantially similar content on the mobile device 17 as well as on the control unit 18. For example, whenever a rider uses a ticket/pass, the user app 12 may communicate the most-recent usage count to the controller app 14, thereby updating the rider-specific information to be provided to a customer service agent on the control unit 18 and also enabling the controller app 14 to monitor the rider's progress towards the applicable free award. Similarly, when the controller app 14 authorizes the product award to a rider, the intimation may be substantially immediately communicated to the user app 12 to allow the user app 12 to provide a visible notification (such as that shown in the portion 99 in FIG. 8B) to the rider. Similarly, the controller app 14 may convey to the user app 12 any user-specific account updates performed by a customer service agent (for example, a change in the “rider type” associated with the user) or by the user (for example, through the online user account) that may affect the fare cap criteria or user's qualification to receive product awards. In certain embodiments, the user app 12 may be allowed to grant the product award when a rider's usage count reaches the relevant qualification count. In that case, the user app 12 may inform the controller app 14 of the grant to enable the controller app 14 to update the client account accordingly. However, as noted before, if the tampering of the user app 12 is of concern or if the user app 12 may be misused to receive unauthorized awards, then only the controller app 14 may be allowed to grant the product award based on the rider meeting the requisite qualification count.

FIG. 9 is a block diagram of an exemplary mobile device 17 according to one embodiment of the present disclosure. As noted earlier, the mobile or wireless device 17 may be a UE, a smartphone, or any other wireless device operable for FC user app-based fare-capping and other transit applications as per particular embodiments of the present disclosure. The wireless device 17 may include a processor 110, a memory 112 (which may, in some embodiments, also include memory on UE's Subscriber Identity Module (SIM) card), a transceiver 114, and an antenna unit 115. The memory 112 may include the program code for the FC user app 12. The program code may be executed by the processor 110, which, in one embodiment, may be similar to the CPU 25 in FIG. 2. Upon execution of the user app's program code by the processor 110, the processor may configure the mobile device 17 to perform various mobile device-specific tasks associated with the fare-capping methodology as per the teachings of the present disclosure. In one embodiment, such tasks may include, for example, the process steps illustrated in FIG. 4 as well those discussed with reference to FIGS. 8A-8B. Such tasks also may include, for example, mobile device-specific (or FC user app-based) operations discussed earlier.

The memory 112 may store data or other related communications received from the control unit 18 (FIG. 2) as well as other content needed to facilitate the transit product-based fare capping as per teachings of the present disclosure. For example, in one embodiment, the memory 112 may store, for example, pre-purchased electronic ticket(s) or digital passes, a passenger's itinerary information, electronic purchase receipts, usage counts and qualification counts for particular transit products, and the like.

The transceiver 114 may communicate with the processor 110 to perform transmission/reception of data, control, or other signaling information (via the antenna unit 115) to/from the controller unit 18 with which the mobile device 17 may be in communication. In particular embodiments, the transceiver 114 may support wireless communication with the controller unit 18 through the Internet 20 to implement the fare capping methodology as per the teachings of the present disclosure. The transceiver 114 may be a single unit or may comprise of two separate units—a transmitter (not shown) and a receiver (not shown). The antenna unit 115 may include one or more antennas. Alternative embodiments of the wireless device 17 may include additional components responsible for providing additional functionality, including any of the functionality identified herein, such as, for example, transmitting ticket usage information to the control unit 18, receiving electronic ticket(s) and/or product-specific qualification counts from the control unit 18, displaying various notifications or messages to the user of the device 17, etc., and/or any functionality necessary to support the solution as per the teachings of the present disclosure. For example, in one embodiment, the wireless device 17 may also include an on-board power supply unit 117 (e.g., a battery or other source of power) to allow the device to be operable in a mobile manner.

In one embodiment, the mobile device 17 may be configured (in hardware, via software, or both) to implement device-specific aspects of product-based fare capping as per teachings of the present disclosure. As noted before, the software or program code may be part of the FC user app 12 and may be stored in the memory 112 and executable by the processor 110. For example, when existing hardware architecture of the device 17 cannot be modified, the functionality desired of the device 17 may be obtained through suitable programming of the processor 110 using the program code of the FC user app 12. The execution of the program code (by the processor 110) may cause the processor to perform as needed to support various aspects related to product-based fare capping as per the teachings of the present disclosure. Thus, although the wireless device 17 may be referred to as “performing,” “accomplishing,” or “carrying out” (or similar such other terms) a function/task or a process or a method step, such performance may be technically accomplished in hardware and/or software as desired.

FIG. 10 depicts a block diagram of an exemplary control unit 18 according to one embodiment of the present disclosure. The control unit 18 may be suitably configured—in hardware and/or software—to implement the product-based fare capping methodology according to the teachings of the present disclosure. The control unit 18 may include a processor 122 and ancillary hardware to accomplish the voucher code-based electronic ticketing-related tasks discussed before. In one embodiment, the processor 122 may be similar to the CPU 32 in FIG. 2. The processor 122 may be configured to interface with a number of external devices. In one embodiment, a number of input devices 124 may be part of the system 18 and may provide data inputs—such as user input, camera images, statistical data, and the like—to the processor 122 for further processing. The input devices 124 may include, for example, a touchpad, a camera, a proximity sensor, a computer keyboard, a touch-screen, a joystick, a physical or virtual “clickable button,” a computer mouse/pointing device, and the like. In FIG. 10, the processor 122 is shown coupled to a system memory 126, a peripheral storage unit 128, one or more output devices 130, and a network interface unit 132. A display screen is an example of an output device 130. In some embodiments, the control unit 18 may include more than one instance of the devices (or components) shown. In various embodiments, all of the components shown in FIG. 10 may be housed within a single housing. In other embodiments, the control unit 18 may not include all of the components shown in FIG. 10. Furthermore, the control unit 18 may be configured as a standalone system, as a server system, as a client system, or in any other suitable form factor (including a distributed processing system).

In particular embodiments, the control unit 18 may include more than one processor (e.g., in a distributed processing configuration). When the control unit 18 is a multiprocessor system, there may be more than one instance of the processor 122 or there may be multiple processors coupled to the processor 122 via their respective interfaces (not shown). The processor 122 may be a System on Chip (SoC) and/or may include more than one Central Processing Units (CPUs).

The system memory 126 may be any semiconductor-based storage system such as, for example, Dynamic Random Access Memory (DRAM), Static RAM (SRAM), Synchronous DRAM (SDRAM), Rambus® DRAM, flash memory, various types of Read Only Memory (ROM), and the like. In some embodiments, the system memory 126 may include multiple different types of semiconductor memories, as opposed to a single type of memory. In certain embodiments, some or all of the system memory 126 may be a cloud-based storage unit or a remotely-implemented network storage. In particular embodiments, the system memory 126 may be a non-transitory data storage medium.

The peripheral storage unit 128, in various embodiments, may include support for magnetic, optical, magneto-optical, or solid-state storage media such as hard drives, optical disks (such as Compact Disks (CDs) or Digital Versatile Disks (DVDs)), non-volatile Random Access Memory (RAM) devices, Secure Digital (SD) memory cards, Universal Serial Bus (USB) memories, and the like. In some embodiments, the peripheral storage unit 128 may be coupled to the processor 122 via a standard peripheral interface such as a Small Computer System Interface (SCSI) interface, a Fibre Channel interface, a Firewire® (IEEE 1394) interface, a Peripheral Component Interface Express (PCI Express™) standard based interface, a USB protocol based interface, or another suitable interface. Various such storage devices may be non-transitory data storage media. In certain embodiments, the peripheral storage may be a cloud-based storage or a network drive.

As mentioned earlier, a display screen may be an example of the output device 130. Other examples of an output device include a graphics/display device, a computer screen, an alarm system, or any other type of data output device. In some embodiments, the input device(s) 124 and the output device(s) 130 may be coupled to the processor 122 via an I/O or peripheral interface(s).

In one embodiment, the network interface unit 132 may communicate with the processor 122 to enable the control unit 18 to couple to a network or a communication interface. In another embodiment, the network interface unit 132 may be absent altogether. The network interface 132 may include any suitable devices, media and/or protocol content for connecting the control unit 18 to a network/interface—whether wired or wireless. In various embodiments, the network may include Local Area Networks (LANs), Wide Area Networks (WANs), wired or wireless Ethernet, telecommunication networks, or other suitable types of networks/interfaces. For example, the network may be a packet-switched network such as, for example, an Internet Protocol (IP) network like the Internet 20 (FIG. 2), a circuit-switched network, such as the Public Switched Telephone Network (PSTN), or a combination of packet-switched and circuit-switched networks. In another embodiment, the network may be an IP Multimedia Subsystem (IMS) based network, a satellite-based communication link, a Bluetooth network/interface, a Near Field Communication (NFC) based network/interface, a Worldwide Interoperability for Microwave Access (WiMAX) system based on Institute of Electrical and Electronics Engineers (IEEE) standard IEEE 802.16e, an IP-based cellular network such as, for example, a Third Generation Partnership Project (3GPP) or 3GPP2 cellular network like a Long Term Evolution (LTE) network, a combination of cellular and non-cellular networks, a proprietary corporate network, a Public Land Mobile Network (PLMN), an Ethernet connection, and the like.

The control unit 18 may include an on-board power supply unit 135 to provide electrical power to various system components illustrated in FIG. 10. The power supply unit 135 may receive batteries or may be connectable to an AC electrical power outlet. In one embodiment, the power supply unit 135 may convert solar energy or other renewable energy into electrical power.

In one embodiment, a non-transitory, computer-readable data storage medium, such as, for example, the system memory 126 or a peripheral data storage unit 128, such as a removable memory, may store program code or software for the FC controller app 14. In the embodiment of FIG. 10, the system memory 126 is shown to include such program code. The processor 122 may be configured to execute the program code, whereby the control unit 18 may be operative to perform various control unit-specific tasks associated with the product-based fare capping methodology as per the teachings of the present disclosure. In one embodiment, such tasks may include, for example, some or all of the process steps illustrated in FIG. 3. Such tasks also may include, for example, relevant control unit-based operations discussed earlier with reference to FIGS. 2-8. The program code or software may be proprietary software or open source software which, upon execution by the processor 122, may enable the control unit 18 to perform controller unit-specific operations to support the product-based fare capping aspects as per teachings of the present disclosure as well as to support other related actions (such as, for example, interacting with the mobile device 17). In certain embodiments, the program code for the FC controller app 14 may operate in conjunction with additional program code in the memory 126 to enable the control unit 18 to perform the control unit-related tasks.

In the preceding description, for purposes of explanation and not limitation, specific details are set forth (such as particular architectures, interfaces, techniques, etc.) in order to provide a thorough understanding of the disclosed technology. However, it will be apparent to those skilled in the art that the disclosed technology may be practiced in other embodiments that depart from these specific details. That is, those skilled in the art will be able to devise various arrangements which, although not explicitly described or shown herein, embody the principles of the disclosed technology. In some instances, detailed descriptions of well-known devices, circuits, and methods are omitted so as not to obscure the description of the disclosed technology with unnecessary detail. All statements herein reciting principles, aspects, and embodiments of the disclosed technology, as well as specific examples thereof, are intended to encompass both structural and functional equivalents thereof. Additionally, it is intended that such equivalents include both currently known equivalents as well as equivalents developed in the future, such as, for example, any elements developed that perform the same function, regardless of structure.

Thus, for example, it will be appreciated by those skilled in the art that block diagrams herein (e.g., in FIG. 2) can represent conceptual views of illustrative circuitry or other functional units embodying the principles of the technology. Similarly, it will be appreciated that the flowcharts in FIGS. 3-4 represent various processes or tasks which may be substantially performed by a respective processor (e.g., the processor 110 in FIG. 9 or the processor 122 in FIG. 10, as applicable). Such a processor may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Some or all of the functionalities described above in the context of FIGS. 1-8 also may be provided by a respective processor 110 or 122, in the hardware and/or software. Any of the processors 110 and 122 may employ distributed processing in certain embodiments.

When certain inventive aspects require software-based processing, such software or program code may reside in a computer-readable data storage medium. As noted earlier with reference to FIG. 10, such data storage medium may be part of the peripheral storage 128, the system memory 126, and/or the processor's 122 internal memory (not shown). In case of the embodiment in FIG. 9, such data storage medium may be part of the memory 112 or the processor's 110 internal memory (not shown). In certain embodiments, the processors 110 and 122 may execute instructions stored on a respective such medium to carry out the software-based processing. The computer-readable data storage medium may be a non-transitory data storage medium containing a computer program, software, firmware, or microcode for execution by a general purpose computer or a processor mentioned above. Examples of computer-readable storage media include a ROM, a RAM, a digital register, a cache memory, semiconductor memory devices, magnetic media such as internal hard disks, magnetic tapes and removable disks, magneto-optical media, and optical media such as CD-ROM disks and DVDs.

Alternative embodiments of the control unit 18 according to inventive aspects of the present disclosure may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features. As mentioned before, various FC controller application-based functions and FC user application-based functions discussed herein may be provided through the use of hardware (such as circuit hardware) and/or hardware capable of executing software/firmware in the form of coded instructions or microcode stored on a computer-readable data storage medium (mentioned above). Thus, such functions and illustrated functional blocks are to be understood as being either hardware-implemented and/or computer-implemented, and thus machine-implemented.

The foregoing describes a transit fare approach that offers a transit agency the ability to cap how many transit passes of a particular type in a given fare cycle would be equivalent of buying a discounted transit product (like a weekly pass, a bi-weekly pass, or a monthly pass). Once this equivalent is reached by a rider, the system automatically gives the rider the corresponding discount pass for free. The free pass remains activated and good for the remainder of the fare cycle. The FC application software provides a user app for the rider's mobile device and a controller app for a control unit of the transit agency, both of which operate in conjunction with each other to monitor the use of transit passes by the rider to determine when the rider qualifies for the fare cap-based free transit product and subsequently reward the rider with the free use of the appropriate transit product.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method in a control unit associated with a transit system, the method comprising:
selecting a qualification count for a transit product, wherein the qualification count specifies a total number of transit passes of a particular type needed to be used by a transit rider in the transit system during a pre-defined time period to qualify for a free use of the transit product;
determining that the transit rider has satisfied the qualification count within the pre-defined time period; and
automatically awarding the transit rider the free use of the transit product for a remainder of the pre-defined time period.

2. The method of claim 1, wherein the pre-defined time period is one of the following:
24 hours from an earliest-used transit pass;
a fixed time of a day occurring after a day of the earliest-used transit pass;
seven days from the earliest-used transit pass;
a fixed time on the first day of a month occurring after a month of the earliest-used transit pass;
a fixed time of an nth day from the earliest-used transit pass, wherein “n” has a value selected from the set consisting of the values {7, 30, 31}.

3. The method of claim 1, wherein the transit product is one of the following:
a weekly pass;
a bi-weekly pass; and
a monthly pass.

4. The method of claim 1, wherein the transit passes are of one of the following types:
a single-ride pass;
a round-trip pass; and
a multi-ride pass.

5. The method of claim 1, wherein the qualification count is based on a type of the transit rider, and wherein the method further comprises performing the following using the control unit:
receiving an indication of the type of the transit rider; and
selecting the qualification count based on the received indication.

6. The method of claim 5, wherein the transit rider is of one of the following types:
a commuter;
a senior citizen;
a tourist;
a student; and
a teacher.

7. The method of claim 1, wherein selecting the qualification count includes:
receiving the qualification count from an external source.

8. The method of claim 7, wherein the external source is one of the following:
a human operator; and
a data processing system.

9. The method of claim 1, wherein the method further comprises performing the following using the control unit:
determining a use event as one of the following:
the transit rider activating a specific transit pass, and
the specific transit pass expiring due to non-activation by the transit rider within a pre-determined time limit; and
establishing that the specific transit pass is used at a time instant when the use event occurs.

10. The method of claim 1, wherein said determining comprises:
maintaining a usage count for the transit product, wherein the usage count indicates how many transit passes are used by the transit rider during the pre-defined time period; and
confirming that the usage count has reached the qualification count during the pre-defined time period.

11. The method of claim 10, wherein said maintaining comprises the following:
incrementing the usage count for every transit pass that is activated by the transit rider within a pre-determined time limit and at a time instant different from other transit passes activated within the pre-determined time limit; and
further incrementing the usage count for every transit pass that expires due to non-activation by the transit rider within the pre-determined time limit.

12. A method in a mobile device communicatively coupled to a control unit in a transit system, the method comprising:
receiving a qualification count for a transit product, wherein the qualification count specifies a total number of transit passes of a particular type needed to be used in the transit system by a transit rider associated with the mobile device during a pre-defined time period to qualify for a free use of the transit product;
generating a usage count for the transit product, wherein the usage count indicates how many transit passes are used by the transit rider during the pre-defined time period;
confirming that the usage count has reached the qualification count during the pre-defined time period; and
informing the transit rider that the transit product is free for use by the transit rider for a remainder of the pre-defined time period.

13. The method of claim 12, wherein said confirming comprises:
transmitting the usage count to the control unit; and
receiving an intimation from the control unit that the transit rider has satisfied the qualification count.

14. The method of claim 12, wherein said receiving comprises:
receiving the qualification count from the control unit.

15. The method of claim 12, wherein the method comprises further performing the following using the mobile device:
displaying the qualification count and the usage count on a display screen of the mobile device.

16. The method of claim 12, wherein said informing comprises performing at least one of the following using the mobile device:
providing a visible notification of the free use of the transit product on the mobile device; and
providing an audible notification of the free use of the transit product on the mobile device.

17. The method of claim 12, wherein said generating comprises the following:
incrementing the usage count for every transit pass that is activated by the transit rider within a pre-determined time limit and at a time instant different from other transit passes activated within the pre-determined time limit; and
further incrementing the usage count for every transit pass that expires due to non-activation by the transit rider within the pre-determined time limit.

18. A control unit in a transit system, wherein the control unit comprises:
a memory for storing program instructions; and
a processor coupled to the memory and operable to execute the program instructions, which, when executed by the processor, cause the control unit to:
select a qualification count for a transit product, wherein the qualification count specifies a total number of transit passes of a particular type needed to be used by a transit rider in the transit system during a pre-defined time period to qualify for a free use of the transit product;
determine that the transit rider has satisfied the qualification count within the pre-defined time period; and
automatically award the transit rider the free use of the transit product for a remainder of the pre-defined time period.

19. The control unit of claim 18, wherein the transit passes are of one of the following types:
a single-ride pass;
a round-trip pass; and
a multi-ride pass;
and wherein the transit product is one of the following:
a weekly pass;
a bi-weekly pass; and
a monthly pass.

20. The control unit of claim 18, wherein the program instructions, upon execution by the processor, cause the control unit to:
select the qualification count based on a type of the transit rider;
maintain a usage count for the transit product, wherein the usage count indicates how many transit passes are used by the transit rider during the pre-defined time period; and
confirm that the usage count has reached the qualification count during the pre-defined time period.
